(19) United States
(12) Patent Application Publication
(10) Pub. No.: US 2008/0277624 A1
(43) Pub. Date: Nov. 13, 2008

(54) Photoluminescent Material

(76) Inventor: Nagendra N. Beladakere, Victoria (AU)

Correspondence Address: DIEHL SERVILLA LLC, 77 BRANT AVE, SUITE 210, CLARK, NJ, 07066, US

(21) Appl. No.: 12/091,626

(22) PCT Filed: Oct. 27, 2006
(86) PCT No.: PCT/AU2006/001609

§ 371 Date: Jul. 9, 2008

(30) Foreign Application Priority Data
Oct. 28, 2005 (AU) 2005905974

(51) Int. Cl. C09K 11/78

(52) U.S. Cl. 252/301.4 H

(57) ABSTRACT

A photoluminescent material comprising a composition of halogen-substituted alkaline earth metal aluminate doped with at least one rare-earth element activator. The alkaline earth metal is selected from one or more of Sr, Ca, Mg and Ba. The halogens can be F, Cl, Br and I. The invention includes a method of manufacturing the photoluminescent material and use of the photoluminescent material in long after-glow products such as water based and/or solvent based paints and extruded from plastics, ceramic glazes and the like.

### FIELD

The invention relates to long-decay photoluminescent material comprised of rare-earth activated, divalent, halogen modified aluminates and methods of preparing such long-decay photoluminescent material.

### BACKGROUND

Photoluminous materials have existed in many forms, some occurring naturally in the form of phosphorescent inorganic minerals in the earth. A series of special minerals, amongst others, which give rise to the phenomenon of photoluminescence are known as the lanthanide series of elements in the periodic table. The lanthanides belong to a group commonly known as rare earths. The unique electronic structure of these elements with f-electrons and partially filled d-levels offer an excellent opportunity to create electron triplet states with long lifetimes. These states in turn give rise to phosphorescence. When very small amounts of compounds such as oxides, halides, nitrates, etc of these lanthanide elements are amalgamated with select inorganic compounds and sintered under controlled heat and atmospheric conditions, the result can be a photoluminous material. Such material absorbs energy from radiant sources when exposed to them, and emits this energy in the form of luminous photons over a long period when compared to the short exposure time.

Honeywell's subsidiary Riedel De Haen of Germany were among the early developers of a photoluminous pigment based on zinc sulphide, which has been produced commercially since the early 1900s.

More recently other phosphorescent crystals “doped” with rare earths such as europium and dysprosium as activators have been used. For example, aluminates of calcium and strontium doped with rare earths have been synthesized to give an improved intensity of illumination over a longer period when compared to zinc sulphide. The rare-earth elements in these crystals are often referred to as ‘activators’ as their unique electronic configuration is the source of phosphorescence. These substances, sometimes known as ‘glow in the dark’ pigments in industry and trade parlance, are being more commonly used in domestic and industrial situations.

Such materials have been used in making luminous solvent based paints, articles moulded and extruded from plastics, ceramic glazes and many others. However, incorporating most long-decay photoluminescent material into other materials poses many challenges, sometimes insurmountable, as the crystals are abrasive and can damage the machinery. The aluminates, for example, can form a hard cementitious mass in water thus making it difficult to use in water-based formulations.

It is desirable to produce an improved photoluminescent material with persistent after-glow characteristics and that can be incorporated into other materials. It is further desired that the photoluminescent material, once incorporated into a formulation or final product, retain its stability particularly in water.

### SUMMARY

In a first aspect of the present invention there is provided a photo-luminescent material comprising a halogen-substituted, alkaline earth metal aluminate doped with at least one rare earth element activator.

In one embodiment the present invention provides a photo-luminescent material comprising a composition of:

xMO.(1−x)MX₂.yAl₂O₃:aR1,bR2 (1)

wherein M is an alkaline earth metal selected from one or more of the group consisting of Sr, Ca, Mg and Ba;

X is a halogen selected from one or more of the group consisting of F, Cl, Br and I;

R1 and R2 are rare-earth element activators selected from one or more of the group consisting of Ce, Pr, Nd, Pm, Sm, Eu, Gd, Tb, Dy, Ho, Er, Tm, Yb and Lu; and

the variables x, y, a and b are:
0<x<1.0
1≦y≦10
0<a<0.05
0≦b<0.05

In a further aspect the present invention provides a method of manufacturing a photoluminescent material as described above. The method comprises the steps of providing an alkaline earth metal aluminate substituting oxygen anions with halide ions and doping with at least one rare earth element activator before or after halide substitution.

In an even further aspect, the present invention provides a use of said long decay photoluminescent material in long after-glow products.

### DETAILED DESCRIPTION

In a first aspect of the present invention there is provided a photo-luminescent material comprising a composition of a halogen-substituted, alkaline earth metal aluminate, doped with at least one rare earth metal activator.

In one embodiment the present invention provides a photo-luminescent material comprising a composition of:

xMO.(1−x)MX₂.yAl₂O₃:aR1,bR2 (1)

wherein M is an alkaline earth metal selected from one or more of the group consisting of Sr, Ca, Mg and Ba;

X is a halogen selected from one or more of the group consisting of F, Cl, Br and I;

R1 and R2 are rare-earth element activators selected from one or more of the group consisting of Ce, Pr, Nd, Pm, Sm, Eu, Gd, Tb, Dy, Ho, Er, Tm, Yb and Lu; and

the variables x, y, a and b are:
0<x<1.0
1≦y≦10
0<a<0.05
0≦b<0.05
It is to be understood that the above formula (1) and similar formulae disclosed herein unless indicated otherwise, are intended to represent the ratio of elemental constituents present in the composition of long-decay photoluminescent material without necessarily suggesting or representing the molecular composition of the individual crystal phases present in the photoluminescent material. The above formula has been calculated using techniques from oxide data generated by analytical techniques such as X-ray fluorescence, gravimetric analysis, ICP-AES (Inductively Coupled Plasmon Atomic Electron Spectroscopy) etc.

### Alkaline Earth Metal Aluminate

Alkaline earth metal aluminates comprise a complex of an alkaline earth metal oxide (“divalent metal oxide MO”) and aluminate Al₂O₃.

The divalent metal oxide component in the divalent metal aluminate, as represented by MO in the formula (1) is selected from one or more of the group consisting of SrO, CaO, MgO and BaO.

In one embodiment the metal oxide is SrO. In other embodiments of the invention, the metal oxide component comprises a combination of metal oxides. For example, SrO and CaO, SrO and MgO, SrO and BaO, CaO and MgO, CaO and BaO, and MgO and BaO. A combination of three of the metal oxides or a combination of all four metal oxides mentioned above is also envisaged. In a preferred embodiment, the metal oxide component represents at least one metal oxide selected from the group consisting of CaO and SrO.

In another embodiment, the metal oxide component consists of CaO and SrO.

### Rare Earth

The amount of rare earth element(s) present in the photoluminescent material can be extremely small relative to the other constituents of the photoluminescent material, and still contribute the characteristics of photoluminescence to the material. The variable “a” which defines the amount of the rare earth element activator(s) can be very small and its lower limit is defined as being greater than 0 to indicate this. In one embodiment a second rare earth is present in the composition. The amount of the second rare earth is defined by the range of 0≦b<0.05.

According to one embodiment, R₁ is Eu²⁺. This rare earth activator can be present as the only rare earth activator (i.e. b=0, and R² is not present).

However, enhanced long decay photoluminescence can be observed if the Eu²⁺ activator is combined with a second or further additional rare earth activators in the photoluminescent material. That is, longer decay can be observed when b>0, and R² is present.

The rare-earth element(s) represented by R1 and R2 in formula (1) are selected from one or more of the group consisting of Ce, Pr, Nd, Pm, Sm, Eu, Gd, Tb, Dy, Ho, Er, Tm and Yb and Lu. In one preferred embodiment, R¹ is Eu. In another preferred embodiment, R₁ is Eu, and R₂ is a rare earth element selected from one or more of Ce, Pr, Nd, Pm, Sm, Gd, Tb, Dy, Ho, Er, Tm and Yb and Lu, and b>0. In still another preferred embodiment, R₂ is selected from one or more of Dy, Ce, Nd, Pr, Sm, Tb, Tm and Yb.

Embodiments in which more than two rare earths are present are envisaged in the present invention. The addition of more rare earths does not materially effect the characteristics, particularly the stability, of any products containing the photoluminescent material, as the rare earths are present in relatively small amounts. The limiting factor to adding more rare earths relates to the added cost as they are expensive materials.

In embodiments where the photoluminescent material containing two rare earths as activators, it is believed that the divalent Eu²⁺ functions mainly as a luminescent center, whereas, a second rare-earth activator serves as a trapping site.

In materials containing Eu²⁺ as the only rare earth activator may be more suited to applications which require shorter after-glow characteristics such as coatings on the internal surfaces of lamp shades. These coatings assist in amplifying the brightness of the lamp, but do not extend to after-glow when the lamp is switched off.

In an embodiment comprising two or more rare earth elements it is preferred that one of the rare earths is present in a larger amount than the other(s). For example, if one of the rare earths is Eu²⁺, the range of molar ratios of Eu²⁺: other rare earth(s) can be defined by: 1:0.01 to 1:50. A preferred ratio range 1:0.1 to 1:10. Another preferred ratio range is 1:2 to 1:5.

The choice of rare earth present in the composition as well as the choice of rare earths, if more than one, and their relative ratios determines the nature of the glow of the photoluminescent material. This ultimately determines the nature of the glow of the final product into which the long-decay photoluminescent material is incorporated. For example, a photoluminescent material of the formula:

xSrO.(1−x)SrF₂. yAl2O₃:aEu,bDy,

in which the following variables are in the range:
0<x<0.9
1≦y≦10
0.0001<a<0.1
0.1<b<0.1, and wherein
b>a
is characterised by a green-glow photoluminescence. A further example of a photoluminescent material of the formula:

xCaO.(1−x)CaF₂.yAl₂O₃:aEu,bDy

in which the following variables are in the range:
0<x<0.9
1≦y≦10
0.001<a<0.01
0.01<b<0.1, and wherein
b>a
is characterised by a blue-glow photoluminescence.

A further example of a photoluminescent material of the formula:

xSrO.(1−x)SrF₂.yAl₂O₃:aEu,bDy

in which the following variables are in the range:
0<x<0.9
1≦y≦10
0.0001<a<0.01
0.01<b<0.1, and wherein
b>a
is characterised by an aqua photoluminescence.

In one embodiment of the photoluminescent material of the present invention, and particularly in the specific examples above, it is particularly preferred that the variable x is in the range: 0.02<x<0.05. Even more preferably, x is between 0.03 and 0.04. Even further preferably, x=0.03 or x=0.04.

### Halogen

The material of the present invention is defined in one embodiment as a halogen-substituted alkaline earth metal aluminate (with rare earth metal doping). That is, the material is based on an alkaline earth metal aluminate in which some of the oxygen is replaced with halogen. The halogen atoms are selected from one or more of the group consisting of F, Cl, Br and I.

The presence of a halide anion in an aluminate alters the overall size of the aluminate and in this invention it has unexpectedly and advantageously been found to impact on the properties of the photoluminescent material, as will be shown below. Particularly, the photoluminescent material shows characteristics of lower hardness and better overall stability when formulated into a final product, when compared with a non-modified aluminate. The lower hardness makes it easier to handle and work with, thus making it easier to use in a final product.

In one of the preferred embodiments, the halogen is F and/or Cl. They are highly electronegative thus making them most suitable. In another preferred embodiment, fluorine is the sole halogen present in the composition.

In one embodiment, fluorine is present in a molar ratio of 1:1 of fluorine to one or more other halogen atoms.

It is envisaged that the photoluminescent material can be tailored to provide the desired glow (colour) and decay characteristics, as well as stability and hardness characteristics by adjusting the stoichiometric ratio of each component in the aluminate and by selecting the rare-earth activator and/or proper combination of rare-earth activators in the subject rare-earth activated, halogen substituted alkaline earth metal aluminate.

Without being limited to the theories proposed, it is hypothesized that a reduction in the number of oxygen atoms in the composition leads to an increase in stability. It is also hypothesized that an increase in the number of ionic bonds in the composition results in a reduction in hardness of the composition. These advantageous characteristics of the composition of the present invention are shown below and in the examples.

### Stability

The stability characteristics of a particular photoluminescent material can be determined by measuring its reaction in water and to other chemical substances. The results of such an investigation on the photoluminescent material of the present invention can be seen in examples 5, 6 and table 1 in which the reactivity of the following example of the photoluminescent material of the present invention was investigated:
0.04SrO. 0.96SrF₂. Al₂O₃:0.002Eu, 0.008Dy

The photoluminescent materials of the present invention display substantially no reaction with water and none or very little reaction with several acids, as tabulated.

By comparison, the rare earth activated non-modified aluminate loses its afterglow effect on reaction with water. The halide substituted material is observed to glow approximately 15-20% brighter when moist, in stark contrast to the loss of brightness of the aluminate without halide substitution. The characteristics of substantially no reaction with water make the materials of the present invention suitable for a wide variety of applications, including safe use in the home.

### Hardness

The photoluminescent material of the present invention is expected to be easier to convert to powder as it is softer. This characteristic makes it easier to formulate into other products. The photoluminescent material is easier to handle and is not as abrasive, when in contact with machinery as the non-modified aluminate counterpart.

The long decay photoluminescent material of the present invention also produces photoluminescence with unexpectedly high brightness levels for unexpectedly long decay periods.

### Brightness

The photoluminescent characteristics of a particular photoluminescencent material can be determined by measuring the photoluminescent emission data which is measured according to the method described in a widely accepted standard for measuring phosphorescence, DIN 67510 Part 1. This is described further under example 7 below. The powder samples are stored under subdued lighting for approximately 20 minutes to allow residual luminescence to decay and then exposed to xenon light. The sample is illuminated for 5 minutes and the luminescence is measured according to that described in the DIN standard.

The photoluminescent material specified in examples 1 and 2 is much brighter and retains brightness for a longer period of time when compared with the traditional zinc sulphide pigment traditionally utilised in products providing photoluminescence, See example 7.

While the present invention is not intended to be limited by the current theories or beliefs disclosed herein and although it has not yet been confirmed, it is believed that one or more of the enhanced features of stability, hardness and/or brightness of the composition is achieved by the substitution of halide ions for some of the oxygen anions in the divalent metal aluminate. It is envisaged that substitution of halide ions for oxygen anions can occur anywhere in the divalent metal aluminate and not only at the metal oxide position as defined in formula (1) above. It is suggested that some oxygen anions in Al₂O₃ position may also be substituted.

The way in which a composition of material is represented can be in terms of its molecular weight, atomic or molecular formula.

The photoluminescent material of the present invention represented by the molecular formula above, can also be represented by a formula expressed in terms of mol/100 grams according to (2) below:

aM.bAl.cX.O:fR (2)

wherein M is an alkali earth metal selected from one or more of the group consisting of Sr, Ca, Mg and Ba;

X is a halogen selected from one or more of the group consisting of F, Cl, Br and I;

R is a rare-earth element activator selected from one or more of the group consisting of Ce, Pr, Nd, Pm, Sm, Eu, Gd, Tb, Dy, Ho, Er, Tm and Yb; and the variables a, b, c and f can be defined as:

0.25<a<0.45,
0.3<b<0.55,
0.5<c<1, and
0.005<f<0.5.

In one embodiment there is provided a long afterglow alkali earth haloaluminate-aluminate comprising of a material expressed by a general formula

aM.bAL.cX.O:fR

Where M is an alkali earth metal (is at least one from a selection of) Sr, Ca, Mg and Ba; X is a halogen selected from F, Cl, Br, and I; R is a rare-earth element activator at least one selected from the elements Ce, Pr, Nd, Pm, Sm, Eu, Gd, Tb, Dy, Ho, Er, Tm and Yb; a, b, c and f are variables having values in moles per 100 grams where

### 0.25.LE.. a..LE.0.45

### 0.3.LE..b..LE.0.55

### 0.5.LE..c..LE.1

### 0.005.LE..f..LE.0.5

Based upon the above representation, one specific example of a photoluminescent material of the present invention can be expressed as:

0.393Sr.0.412Al0.64F.O:0.002Eu,0.008 Dy

as calculated from the XRF data.

This gives a molecular formula in number of atoms as:

SrAl_{2.08}F_{1.89}O₃:Eu_{0.004}Dy_{0.016}

This equates to the photoluminescent material of Formula I xMO.(1−x)MX₂.Al₂O₃:(aRE1,bRE2), when x is approximately 0.04. This is the specific embodiment made in example 1. The formula of the photoluminescent material of example 2 expressed as:

0.04CaO.0.90SrF₂.Al₂O₃:0.0019Eu,0.009Dy.

The empirical formula of the same example as calculated from XRF data can be expressed as:

0.393Ca.0.412Al.0.64F.O:0025Eu,0.010Dy.

The photoluminescent material of example 3, expressed as:

0.04SrO. 0.96SrF₂. 2Al₂O₃:0.0019Eu,0.009Dy.

The empirical formula of the same example as calculated from XRF data can be expressed as:

0.258Sr.0.513Al.0.548F.O:0.0019Eu,0.009Dy.

The photoluminescent material of example 4a, expressed as:

0.75SrO.0.25SrF₂.1.75Al₂O₃:0.0024Eu,0.0085Dy.

The empirical formula of the same example as calculated from XRF data can be expressed as:

0.447Sr.0.536Al.0.512F.O:0.0024Eu,0.0085Dy.

The photoluminescent material of example 4b, expressed as:

0.04SrO.0.96SrF₂.6Al₂O₃:0.005Eu,0.012Dy.

The empirical formula of the same example as calculated from XRF data can be expressed as:

0.481Sr.0.521Al.0.53F. 0:0.005Eu,0.012Dy.

The above representations show that all the current examples are within the scope of the formula (2) above.

In a further aspect the present invention provides a method of manufacturing a photoluminescent material as described above. It involves providing the photoluminescent material described above, characterised by a blue-glow.

The starting materials are combined and prefired at 130° C., then cooled, crushed and sintered at 280° C. Boric acid is incorporated, followed by a second firing step, cooling and crushing to powder. The powder is then treated with ammonium bifluoride for substitution of some of the oxygen anions with fluoride anions. Other sources of the halide ions such as fluoride can be used provided there is interaction sufficient to result in halide substitution of some of the oxygen anions.

It is envisaged that some of the halide, for example fluoride, is not incorporated into the aluminate lattice, but instead remains in addition to non-modified aluminate and/or the aluminate that has been modified by the insertion of halide anions. It is envisaged that the presence of such a mixture does not disadvantage the performance characteristics of the photoluminescent material. Some of the unreacted halide source can have bright initial glow.

In an even further aspect, the present invention provides a use of said photoluminescent material in long after-glow products. It is envisaged that by tailoring the stoichiometric ration of component aluminate and by selecting the rare-earth activator and/or proper combination of rare-earth activators, a variety of photoluminescent material can be manufactured to suit a variety of applications. For example, relatively shorter glow photoluminescent material can be used for internal coatings of lamps. The low reactivity in water makes the photoluminescent material of the invention, and specific embodiments thereof, suitable for water-based applications such as water-based paints and/or dispersions. It is also suitable for incorporation into plastics, extrudable and mouldable, water based and solvent based paints, ceramics, coatings, articles moulded and extruded from plastics, ceramic glazes and the like.

The composition of the present invention may include further additives such as suspension aids and/or colouring agents. An optical brightening pigment that is non-photoluminescent in nature can also be used. However it is preferred to keep additives to a minimum to avoid interference with the photoluminescent effect of the final product.

### BRIEF DESCRIPTION OF THE FIGURES

FIG. 1 is an X-ray diffraction pattern of a photoluminescent material 0.04SrO. 0.96SrF₂. Al₂O₃: 0.002Eu, 0.008Dy according to the present invention;

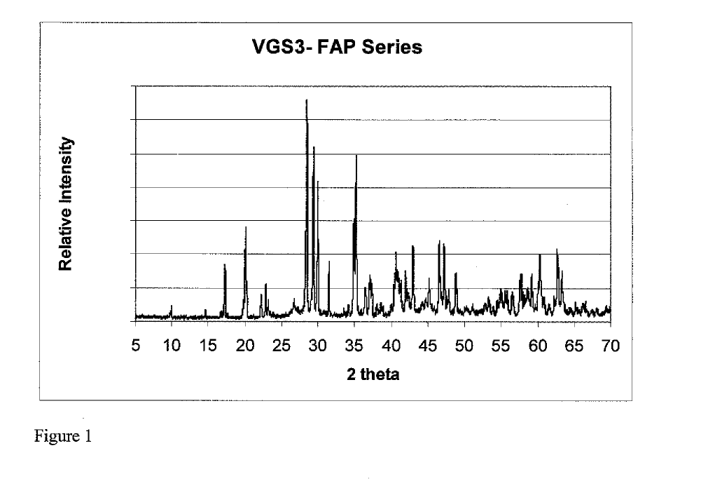

FIG. 2 is an FTIR spectra of a photoluminescent material of the formula: 0.04SrO. 0.96SrF₂. Al₂O₃: 0.002Eu, 0.008Dy.

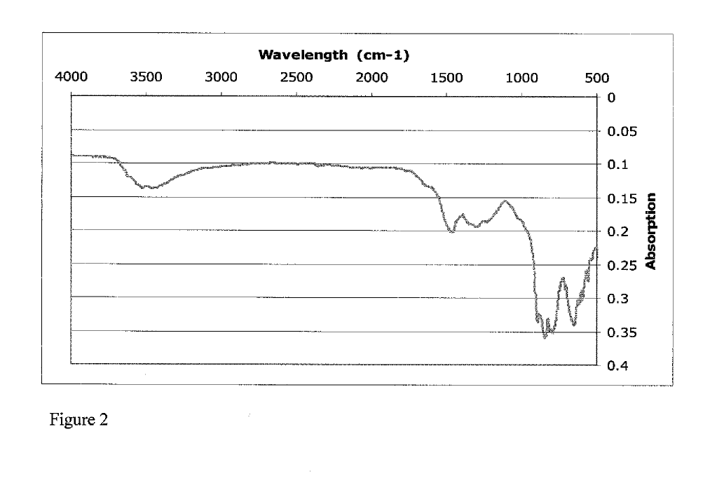

FIG. 3 is an FTIR spectra of a photoluminescent material of the formula: 0.75SrO. 0.25SrF₂. 1.75Al₂O₃: 0.0024Eu, 0.0085Dy.

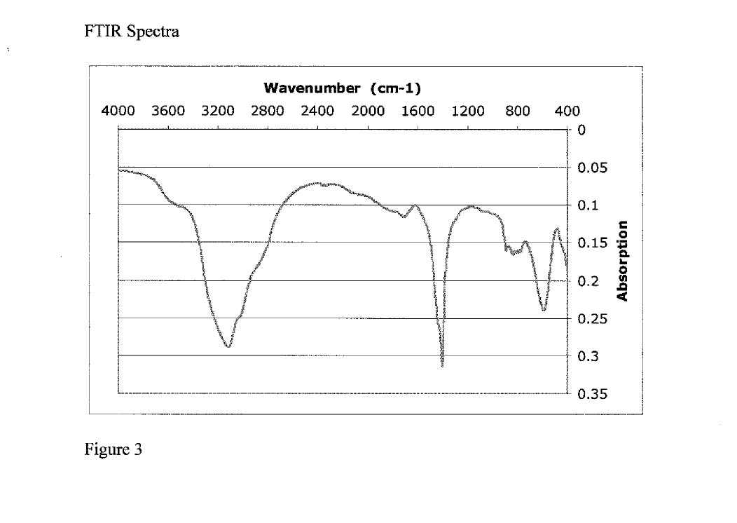

FIG. 4 is an X-ray diffraction pattern of the photoluminescent material 0.75SrO. 0.25SrF₂. 1.75Al₂O₃: 0.0024Eu, 0.0085Dy according to the present invention.

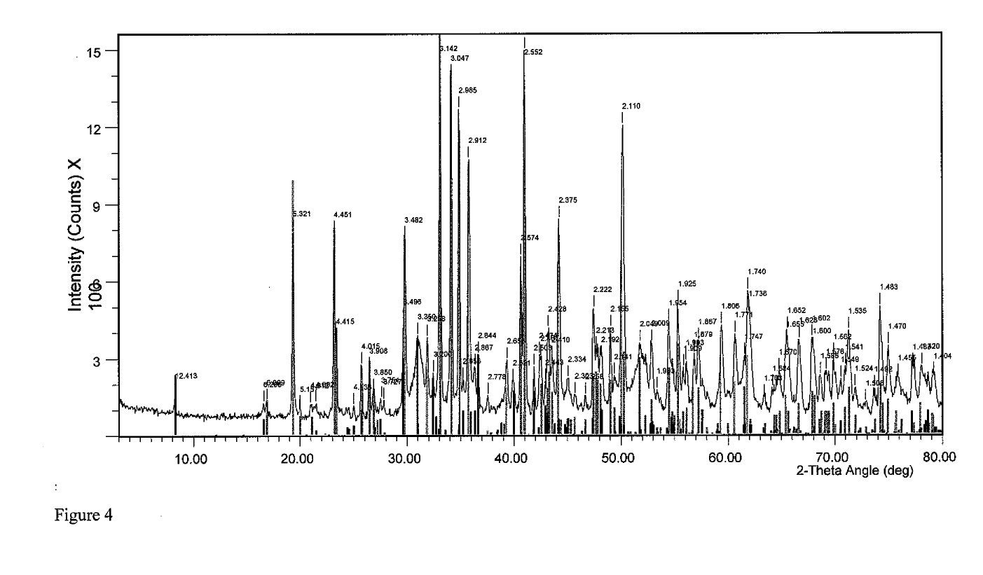

FIG. 5 shows the emission spectrum of the photoluminescent material 0.04SrO, 0.96SrF₂, Al₂O₃:0.02Eu, 0.08Dy.

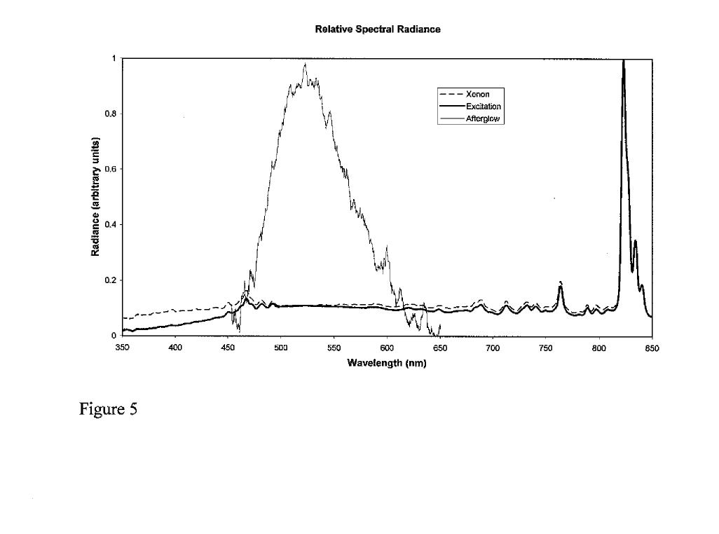

### EXAMPLES

The invention will now be described in detail by way of reference only to the following non-limiting examples and drawings.

### Materials and Methods

All starting materials were purchased from various sources such as Ajax Fine chemicals, Redox chemicals and local hardware stores. SrCO₃, ABF and boric acid were bought from Ajax Fine chemicals in Australia. Rare earth compounds and oxides were bought from Metall Company in China and 85% acetic acid was bought from Redox Chemicals in Australia.

### Example 1

### Preparation of 0.04SrO. 0.96SrF₂. Al₂O₃: 0.002Eu, 0.008Dy

The following materials are weighed using a laboratory balance.

| | |
|---|---|
| SrCO₃ | 14.86 g |
| Al(OH)₃ | 7.8 g |
| NH₄HF₂ | 6.84 g |
| Eu₂O₃ | 0.094 g |
| Dy₂O₃ | 0.187 g |
| H₃BO₃ | 0.84 g |

### Method:

The strontium carbonate, aluminium hydroxide, europium oxide and dysprosium oxide were mixed thoroughly using a mortar and pestle, then transferred to a crucible. The contents are then prefired at 130° C. for 2 hours. The mixture is cooled, crushed and mixed in the crucible and sintered in an oven for 4 hours at 280° C.

The crucible is removed from the oven, the mixture cooled and crushed again.

H₃BO₃ is added to this residue and is mixed thoroughly using a pestle.

The resulting mix is fired for a second time at 1200° C. for 1 hour, followed by cooling and further crushing to a powder consistency.

The powder is then treated with 100 mls of 0.5M Ammonium bifluoride solution in the presence of 10 mls of dilute acetic acid of 4% strength. This is done by stirring the precipitate in the liquid for 20 minutes.

The precipitate is then allowed to settle, is collected and washed with 100 mls of distilled water. The precipitate is dried in an oven at 100° C., for approximately 2 hours or until the measured moisture level is below

The resulting powder has a green afterglow with persistent long luminescence. The level of brightness length of luminescence is shown in table 2.

### Example 2

### Preparation of 0.04CaO. 0.96CaF₂. Al₂O₃:0.0025Eu, 0.010Dy

| | |
|---|---|
| CaCO₃ | 6.88 g |
| Al(OH)₃ | 7.8 g |
| NH₄HF₂ | 6.84 g |
| Eu₂O₃ | 0.094 g |
| Dy₂O₃ | 0.187 g |
| H₃BO₃ | 0.84 g |

The method as described in Example 1 was followed. This resulted in a blue afterglow phosphor having persistent long luminescence. The level of brightness and length of luminescence is shown in table 2.

### Example 3

### Preparation of 0.04SrO. 0.96SrF₂. 2Al₂O₃:0.0019Eu, 0.0009Dy

| | |
|---|---|
| SrCO₃ | 2.95 g |
| Al₂O₃ | 6.12 g |
| NH₄HF₂ | 2.85 g |
| Eu₂O₃ | 0.06 g |
| Dy₂O₃ | 0.11 g |
| H₃BO₃ | 0.84 g |

The method as described in Example 1 was followed, except that the second sintering is done for 3 hours at 1100 C.

The resulting powder has a blue-green glow with persistent long luminescence decay.

### Example 4

| | |
|---|---|
| SrCO₃ | 14.76 g |
| Al(OH)₃ | 3.64 g |
| NH₄HF₂ | 11.4 g |
| Eu₂O₃ | 0.06 g |
| Dy₂O₃ | 0.11 g |
| H₃BO₃ | 0.84 g |

### (a) Preparation of: 0.75SrO. 0.25SrF₂. 1.75Al₂O₃: 0.0024Eu, 0.0085Dy

The method as described in Example 1 was followed. The sintering of the final mixture was conducted for 4 hours. The resulting powder has a green glow with persistent long luminescence.

### (b) Preparation of: 0.04SrO. 0.96SrF₂. 6Al₂O₃: 0.005Eu, 0.012Dy

The method as described in Example 1 was followed. The sintering of the final mixture was conducted for 7 hours, resulting in a powder with a green glow and persistent long luminescence.

### Results

### Example 5

### Experiment for Water Stability

10 grams of 0.04SrO. 0.96SrF₂. Al₂O₃: 0.002Eu, 0.008Dy, the product from example 1, was introduced into a container with 100 cc of water at room temperature. The pH of water was measured after the contents had settled in the container. The pH of the slurry is about 7.8. The colour of the powder is pale green and settles at the bottom of the container.

The contents of the container were boiled for 5 minutes and cooled to room temperature. The pH was tested again after 12 hrs. The pH remained at 7.8 indicating there was no reaction or dissolution of pigment with water. Also, the substance had not undergone any changes in color or texture.

### Example 6

### Experiment with Acids and Other Substances

10 grams of 0.04SrO. 0.96SrF₂. Al₂O₃: 0.002Eu, 0.008Dy and log of lanthanide doped strontium aluminate SrO.Al₂O₃ (Eu, Dy) are made to react with the substances as shown in table 1 below:

TABLE 1

| | | Results | |
|---|---|---|---|
| | | | 0.04SO•0.96SrF₂•Al₂O₃: |
| | | SrO•Al₂O₃ | 0.002Eu, |
| Substance | Test method | (Eu, Dy) | 0.008Dy |
| dilute HCl | Immerse in 50 ml | No reaction | No reaction |
| | of acid and | observed | observed |
| | gently shaking | | |
| | at room | | |
| | temperature | | |
| concentrated | Immerse in 50 ml | Some | No reaction |
| HCl | of acid and | reaction | |
| | gently shaking | observed | |
| | at room | | |
| | temperature | | |
| dilute HNO₃ | Immerse in 50 ml | No reaction | No Reaction |
| | of acid and | | |
| | gently shaking | | |
| | at room | | |
| | temperature | | |
| concentrated | Immerse in 50 ml | No reaction | No reaction |
| HNO₃ | of acid and | | |
| | gently shaking | | |
| | at room | | |
| | temperature | | |
| dilute | Immerse in 50 ml | Mild | No reaction |
| H₃PO₄ | of acid and | reaction | |
| | gently shaking | | |
| | at room | | |
| | temperature | | |
| concentrated | Immerse in 50 ml | Reacts with | No reaction |
| H₃PO₄ | of acid and | release of | |
| | gently shaking | heat and | |
| | at room | forms a | |
| | temperature | white | |
| | | cementitious | |
| | | mass. | |
| | | Loss of | |
| | | afterglow | |
| | | brightness | |
| Ethanol | Immerse in 50 ml | No reaction | No reaction |
| | of ethanol | | |
| | and gently | | |
| | shaking at room | | |
| | temperature | | |
| dilute H₂SO₄ | Immerse in 50 ml | No reaction | No reaction |
| | of acid and | at room | |
| | gently shaking | temperature | |
| | at room | | |
| | temperature | | |
| Conc. | Immerse in 50 ml | No reaction | No reaction |
| H₂SO₄ | of acid and | | |
| | gently shaking | | |
| | at room | | |
| | temperature | | |
| NaOH | Immerse in 50 ml | Some | Some mild |
| | of alkali | reactivity | reaction |
| | and gently | with loss | with no |
| | shaking at room | of | significant |
| | temperature | brightness | loss in |
| | | | brightness |
| KOH | Immerse in 50 ml | Some | Some mild |
| | of alkali | reactivity | reaction |
| | and gently | with loss | with no |
| | shaking at room | of | significant |
| | temperature | brightness | loss in |
| | | | brightness |

### Example 7

### Brightness of Afterglow of Photoluminous Material

Brightness was evaluated using a widely accepted standard for measuring phosphorescence: DIN 67510 Part 1.

The resulting powders made according to examples 1 and 2 are conditioned under subdued lighting for a period of 20 minutes to allow residual luminescence to decay, after which they were exposed to xenon light for 5 minutes. Measurements of sample afterglow were made using the same Hagner EC1 Luxmeter. Its measuring aperture is circular with a diameter of 10.5 mm. It was mounted at a distance of 50 mm above the sample, and the luminance of the pigment was determined by measuring the illuminance in this configuration, according to the method in 4.4.2.2. of the Standard. However, the smallest measurable illuminance of the Hagner luxmeter is only 0.1 lux, which is much greater than the required level of 10⁻⁵ lux, so a United Detector Technology silicon photodiode detector (model UDT-10DP) with a circular sensitive area of 1.00 cm² was used for low light measurements, together with a current amplifier to allow measurements of the required sensitivity. The UDT device was calibrated against the Hagner meter in the luminescence of the sample at high light levels in the early part of the decay curve. The photodiode was placed in the same position as the luxmeter, that is, 50 mm above the sample surface. Measurements of luminescence began a few seconds after the xenon lamp was switched off. Tests were performed in a temperature-controlled environment with a temperature in the range 22±1° C.

The sample and detector head were enclosed in a light-tight box to allow monitoring of the luminescent decay down to the required level of 0.3 mcd/m2, without interference from stray light.

| | | | | | Duration |
|---|---|---|---|---|---|
| | Luminance (mcd/m²) after | | | | of |
| Sample | 1 min | 10 mins | 30 mins | 60 mins | afterglow |
| ZnS:Cu | 1 | 1 | 1 | 1 | >170 mins |
| example 1 | 52.67 | 19.58 | 27.3 | 18.9 | >3000 mins |
| example 2 | 27.2 | 13.5 | 23.1 | 14.4 | >1500 mins |

It will be understood to persons skilled in the art of the invention that many modifications may be made without departing from the spirit and scope of the invention.

1. A photoluminescent material comprising a composition of halogen-substituted alkaline earth metal aluminate and doped with at least one rare-earth element activator, wherein the halogen-substituted alkaline-earth metal aluminate is an alkaline earth metal aluminate in which some of the oxygen is replaced with halogen.

2. The photoluminescent material of claim 1 in which the alkaline earth metal is selected from one or more of the group consisting of Sr, Ca, Mg and Ba.

3. The photoluminescent material of claim 1 in which the halogen is selected from one or more of the group consisting of F, Cl, Br and I.

4. The photoluminescent material of claim 1 in which the rare-earth element activator is selected from one or more of the groups consisting of Ce, Pr, Md, Pm, Sm, Eu, Gd, Tb, Dy, Ho, Ev, Tm, Yb and Lu.

5. The photoluminescent material of claim 1, wherein the glow of the material is 15-20% brighter when moist, than its dry counterpart.

6. The photoluminescent material of claim 1, wherein there is substantially no reaction and no loss in glow on reaction with water.

7. The photoluminescent material of claim 1, wherein there is substantially no reaction and no loss in glow on reaction with dilute HCl, concentrated HCl, dilute HNO₃, concentrated HNO₃, dilute H₃PO₄, concentrated H₃PO₄, ethanol, dilute H₂SO₄ and/or concentrated H₂SO₄.

8. The photoluminescent material of claim 1, wherein there is no loss in glow on reaction with NaOH and/or KOH.

9. The photoluminescent material of claim 1, wherein after at least 5 minutes of exposure the material is characterised by illuminance greater than 20 mcd/m² after 1 min, and greater than 10 mcd/m² after 60 minutes.

10. The photoluminescent material of claim 1, wherein the material is characterised by retention of after-glow after 1000 minutes of excitation.

11. The photoluminescent material of claim 1 comprising a composition of:
xMO.(1−x)MX₂.yAl₂O₃:aR1,bR2 (1)
wherein M is an alkaline earth metal selected from one or more of the group consisting of Sr, Ca, Mg and Ba;
X is a halogen selected from one or more of the group consisting of F, Cl, Br and I;
R1 and R2 are rare-earth element activators selected from one or more of the group consisting of Ce, Pr, Nd, Pm, Sm, Eu, Gd, Tb, Dy, Ho, Er, Tm, Yb and Lu; and
the variables x, y, a and b are:
0−x<1.0
1≦y≦10
0<a<0.05
0≦b<0.05.

12. The photoluminescent material of claim 11, wherein the variable x is in the range 0.01≦x≦0.05.

13. The photoluminescent material of claim 11, wherein the variable x is 0.03.

14. The photoluminescent material of claim 11, wherein the variable x is 0.04.

15. The photoluminescent material of claim 11, wherein R represents Eu.

16. The photoluminescent material of claim 11, wherein R represents Eu and one or more rare-earth element activators selected from the group consisting of Ce, Pr, Md, Pm, Sm, Gd, Tb, Dy, Ho, Er, Tm, Yb and Lu.

17. The photoluminescent material of claim 11, wherein R represent Eu and Dy.

18. The photoluminescent material of claim 11, wherein X represents at least one halogen atom selected from F and Cl.

19. The photoluminescent material of claim 11, wherein MO represents at least one divalent metal oxide selected from the group consisting of CaO and SrO.

20. The photoluminescent material of claim 11, wherein X represents more than one halogen atom present in a molar ratio of the 1:1 of fluorine to another halogen atom.

21. The photoluminescent material of claim 11, characterised by a green-glow, wherein the variables are in the range:
0<x<0.9
1≦y≦10,
0.0001<a<0.1,
0.01<b<0.1, wherein
b>a and wherein
M is Sr, X is F, R1 is Eu and R2 is Dy.

22. The photoluminescent material of claim 21, characterised by a green-glow.

23. The photoluminescent material of claim 11, wherein the variables are in the range:
0<x<0.9
1≦y≦10,
0.001<a<0.01,
0.01<b<0.1, wherein
b>a and wherein
M is Ca, X is F, R1 is Eu and R2 is Dy.

24. The photoluminescent material of claim 23, characterised by a blue-glow.

25. The photoluminescent material of claim 11, characterised by an aqua-glow, wherein the variables are in the range:
0<x<0.9
1≦y≦10,
0.0001≦a≦0.01
0.01<b<0.1, wherein
b>a and wherein
M is Sr, X is F, R1 is Eu and R2 is Dy.

26. The photoluminescent material of claim 25, characterised by an aqua-glow.

27. The photoluminescent material according to claim 1 comprising a composition that can be expressed by:
aM.bAl.cX.O:fR (2)
wherein M is an alkali earth metal selected from one or more of the group consisting of Sr, Ca, Mg and Ba;
X is a halogen selected from one or more of the group consisting of F, Cl, Br and I;
R is a rare-earth element activator selected from one or more of the group consisting of Ce, Pr, Nd, Pm, Sm, Eu, Gd, Tb, Dy, Ho, Er, Tm and Yb; and
the variables a, b, c and f can be defined as:
0.25≦a≦0.45,
0.3≦b≦0.55,
0.5≦c≦1, and
0.005≦f≦0.5.

28. The photoluminescent material of claim 27, comprising a composition of:
0.393Sr. 0.412Al 0.64F. O:0.002Eu,0.008 Dy;
0.393Ca. 0.412Al. 0.64F. O:0025Eu, 0.010Dy;
0.258Sr. 0.513Al. 0.548F. O:0.0019Eu, 0.009Dy;
0.447Sr. 0.536Al. 0.512F. O:0.0024Eu, 0.0085Dy; and/or
0.481Sr. 0.521Al. 0.53F. O:0.005Eu, 0.012Dy.

29. A method of manufacturing photoluminescent material of claim 1, comprising providing an alkaline earth metal aluminate, substituting oxygen anions with halide ions and doping with at least one rare earth activator before or after the halide substitution.

30. The method of manufacturing a photoluminescent material of claim 29 wherein said substitution takes place by reacting said alkaline earth metal aluminate with a halide containing acid medium.

31. The method of manufacturing a photoluminescent material of claim 30 wherein said acid medium is ammonium bifluoride solution.

32. A long after-glow product comprising a photoluminescent material of claim 1.

33. The long after-glow product according to claim 32, wherein said long after-glow product is selected from the group consisting of water based paints, solvent based paints, ceramics, coatings, articles moulded and extruded from plastics, and ceramic glazes.
